(19) United States
(12) Patent Application Publication
(10) Pub. No.: US 2020/0055689 A1
(43) Pub. Date: Feb. 20, 2020

(54) METHOD AND APPARATUS FOR STACKING PLASTIC-FILM BAGS

(71) Applicant: LEMO MASCHINENBAU GMBH, Niederkassel-Mondorf (DE)

(72) Inventor: Willi FENNINGER, Windeck (DE)

(21) Appl. No.: 16/604,480

(22) PCT Filed: Apr. 19, 2018
(86) PCT No.: PCT/EP2018/060096

§ 371 Date: Oct. 10, 2019

(30) Foreign Application Priority Data
Apr. 19, 2017 (DE) 10 2017 108 268.9

(51) Int. Cl. B65H 33/16; B65H 31/20; B65H 31/26; B31B 70/98

(52) U.S. Cl. CPC B65H 33/16; B65H 31/20; B65H 2701/191; B31B 70/984; B65H 2511/20; B65H 31/26

(57) ABSTRACT

The invention relates to a device (1) for the stacking, in packets, of bags produced from plastic film, the device (1) having at least one traction means, preferably a toothed belt (2), and at least one carrier (4), on which the bags can be laid flat on each other and which can be fastened to the traction means for driving, and the at least one carrier (4) having at least one means, in particular one driver element (3), for driving the laid bags, the driver element (3) being arranged on the carrier (4) in such a way that the position of the driver element can be changed.

The invention relates to an apparatus forming stacks of plastic-film bags and to a method for operating such an apparatus according to the features of the respective preamble of the two independent patent claims.

DE 10 2011 113 569 already discloses an apparatus and a method for stacking bags made of plastic film. The apparatus has at least one traction element, preferably one or two toothed belts, the apparatus further has at least one so-called stack seat, onto which the bags can be laid flat on one another, and which stack seat can be fastened to the traction element, the stack seat having at least one holder for the stacked bags.

It has been found in practice that, although such an apparatus operates satisfactorily in principle, the format of the plastic bags which can be processed on such an apparatus is limited, since the format of the plastic bags is predetermined by the stack seat on account of the fixedly predetermined spacing of the upwardly facing arms of the plates defining the stack seat. In addition, a relatively large width for the rest surface of the plastic bags is predetermined by the, for example, three-fold arrangement of cassette plates next to one another, with the result that, for example, small-format bags can thus not be deposited on the stack seat in a process-reliable manner.

In addition, the construction of the known stack seat is very complex. Reference is made in this respect to FIGS. 6 to 11 together with the associated description of DE 10 2011 113 569. The cassette plates 8 are mounted onto the unit 10, and three cassette plates 8 are arranged next to one another at a spacing in order to form gripping grooves 9. It has been surprisingly found in practice that the gripping grooves 9 are not required. In addition, the known cassette plates 8 have an approximately U-shaped cross section such that a complex geometry with side walls and interposed clearances results therefrom, making operation complicated. A planar support face is not provided. The overall construction of this known stack seat 6 is thus still more complex by virtue of the fact that the unit 10 is mounted on a T-groove plate 3 by way of its cassette plates 8, and the T-groove plate 3 in turn is fastened to the toothed belt 2 (see also FIG. 14 together with the associated description of DE 10 2011 113 569).

The object of the invention is therefore to enhance the known apparatus and the known method in terms of the flexibility in the deposition of plastic bags after they have been produced in a corresponding apparatus.

This object is achieved in that the apparatus has at least one support on which the bags can be laid flat on one another, the support is fastened to the traction element, in particular a toothed belt, and the at least one support has at least one pusher for driving along the stacked bags. As a result, both the support and the pusher can be of substantially simpler design in their geometry in order to form the so-called stack seat. The support is designed and used such that the bags produced are laid onto it directly onto a planar support face, with the result that a component is thus saved in relation to the known stack seat. Moreover, the support realizes a substantially completely planar support face for the first bag that is directly deposited there. The planar surface for the following bags is maintained in an advantageous manner such that they cannot be disturbingly deformed on the support face, as is the case in the stack seat according to the prior art on account of the spaces forming the gripping recesses.

It is thus of particular advantage and important for the invention if the support is designed to be substantially flat to form a planar support face for the bags and/or the pusher the pusher has an L shape. The substantially planar support face of the support is, where appropriate, continuous except at a narrow groove, in particular a T-groove (as will be described below). The width of the groove causes no deformation of the bags when they are laid on the support.

In a particularly advantageous embodiment of the invention, the apparatus has two supports behind one another, and a pusher is on each support. The position of the pusher on the support is adjustable in that the pusher can be displaced relative to the longitudinal extent of the support. Two supports next to each other and each having a respective pusher, preferably form a seat for the receiving a stack of the plastic bags. The movable arrangement of pushers on their support makes it possible to accommodate any desired format of plastic bags. It is possible that the supports are of narrow construction such that a greater variety of formats is obtained. This is of particular advantage in the case of small bags since the narrow design ensures that the stacked plastic bags hang down to each side of on the support.

Furthermore, preferably at least one of the pushers, preferably all the pushers, has/have a holding formation, such as, for example, rubber lips, brushes or the like. The stacked plastic bags are held in position by friction by such rubber lips, brushes or the like or a combination of similarly acting materials. These positively acting holding forces can be supplemented by spatially limited forces (electrostatic charging) between the plastic bags.

In a development of the invention, the support has at least one groove, in particular a T-section groove that interacts with a fastener, in particular a screw, and with the pusher. The groove, extends in the direction of the longer longitudinal axis of the rectangular support face of the support and interacts with the fastener. For example, the head of a fastening screw engages in the T-groove in such a way that the screw is longitudinally displaceable in the groove for the purpose of format adjustment but cannot be rotated about its own axis. The threaded shank of the screw projects up past the support face of the support and extends up through the pusher, more precisely through an opening (bore) in a foot of the support, which foot bears flat on the support face of the support. A nut is screwed onto the free end of the threaded shank and tightened in order to fix the pusher in its desired position on the support for format setting or loosened in order to displace the pusher relative to the support for the purpose of format changing. For this purpose, the L-shaped pusher affords the advantage that, on the one hand, it forms a foot with an opening for the screw since the foot is directly on the support, and on the other hand has a leg projecting from the foot and forming a boundary and guide for the bags which are to be stacked and collected. To increase the flexibility of the use of the stack seat according to the invention, there can also be provided more than one groove extending in the longitudinal direction of the support, in which case the two or more than two parallel grooves are then arranged in the support.

The format setting with respect to the format of the product (plastic bag) is virtually unlimited, whereas in the cited prior art the format setting is limited by the size of the stack seat described there and each format change of a plastic bag also required another stack seat to be used.

Furthermore, the rest according to the invention for the plastic bags can be provided with known wicket pins, stacking plates or other customary stacking aids and then operates as a known wicket stacker with flexible rest according to the invention for the plastic bags.

The rest according to the invention can also collect plastic bags that do not have a hole. In addition, it has the advantage that, by virtue of the planar face for the stacked bags on the at least one support, the product cannot be damaged or altered.

Furthermore, it is possible that the pushers are eccentrically with respect to a center axis of the support such that the stacking position (also termed saddle position) can be set eccentrically to the stack of plastic bags.

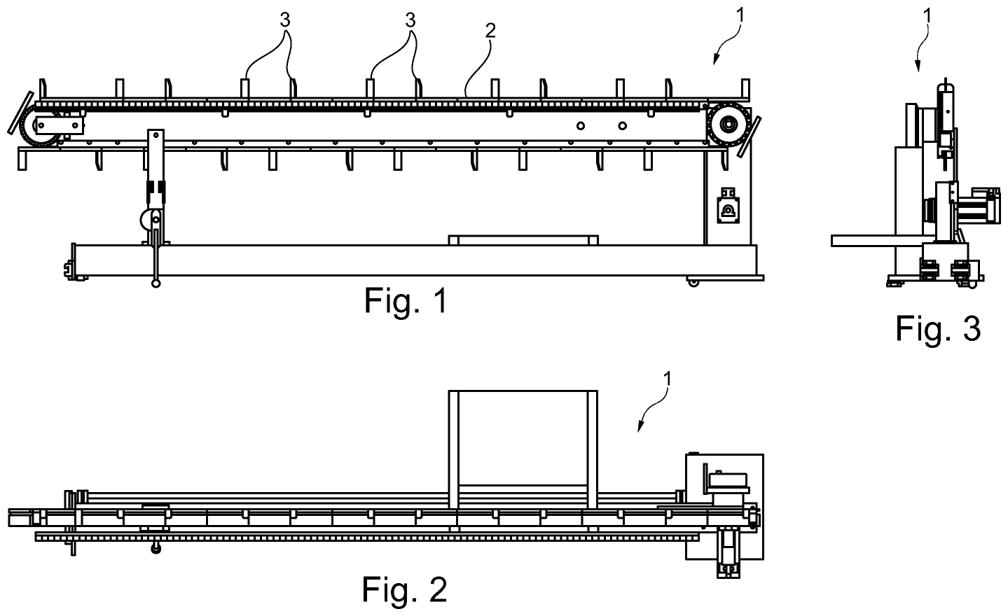

An embodiment of an apparatus according to the invention for making stacks of plastic-film bags is shown in FIGS. 1 to 5.

FIGS. 1 to 3 show an apparatus 1 in different views for stacking, in packets, bags (not shown) made of plastic film, where the apparatus 1 has at least one traction element, preferably a toothed belt 2. The apparatus 1 has at least one pusher 3, preferably a plurality of pushers 3 behind one another and directly or indirectly fastened to the traction element.

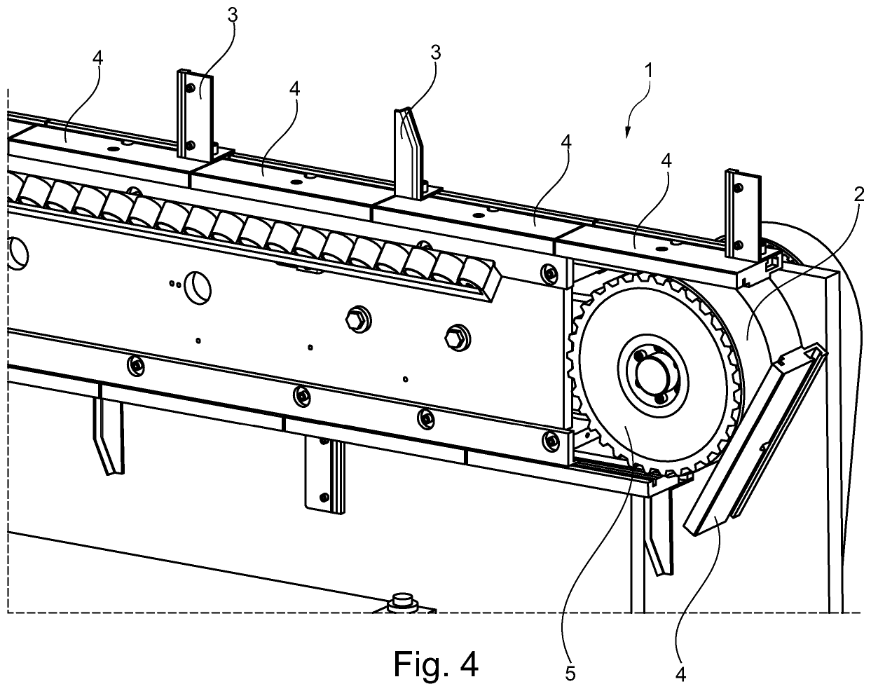

FIG. 4 is a partial view of the apparatus 1 showing how the traction element (toothed belt 2) drives at least one support 4, as illustrated here a row of supports of narrow construction. Each support 4 carries a respective pusher 3. In this embodiment, each support 4 its own pusher 3. It is also conceivable that more than one pusher 3, for example two pushers 3, are on each support 4. It is important that each pusher 3 is designed to be longitudinally adjustable relative to the respective support 4. The flexible positioning of each pusher 3 on its support 4 (or else the spacing of two support elements 3 on their common support 4) makes it possible to set the bearing format for the plastic bags to be stacked. This means that the spacing of two pushers 3 from one another corresponds to an external dimension (such as, for example, the length or width) of the plastic bags to be stacked. The supports 2 are, as shown, of flat construction and have a rectangular design, and the upwardly directed surface carries the bags to be stacked, so that, after their manufacture, the bags are gradually laid onto the support face. This means that a first bag is laid directly flat onto the support face of the support 2, and the following bags are deposited onto the previously deposited bag until a stack of a predetermined number of bags is formed which can be removed. This preferably occurs only when the traction element has moved that support or else those supports that form the support face out of the collecting position into a removal position. The short side of the flat support (for example with an overall dimension of 30 mm, preferably at most of 20 millimeters, more preferably of less than 11 millimeters) is, for example, in a ratio of 1:3 to its long side.

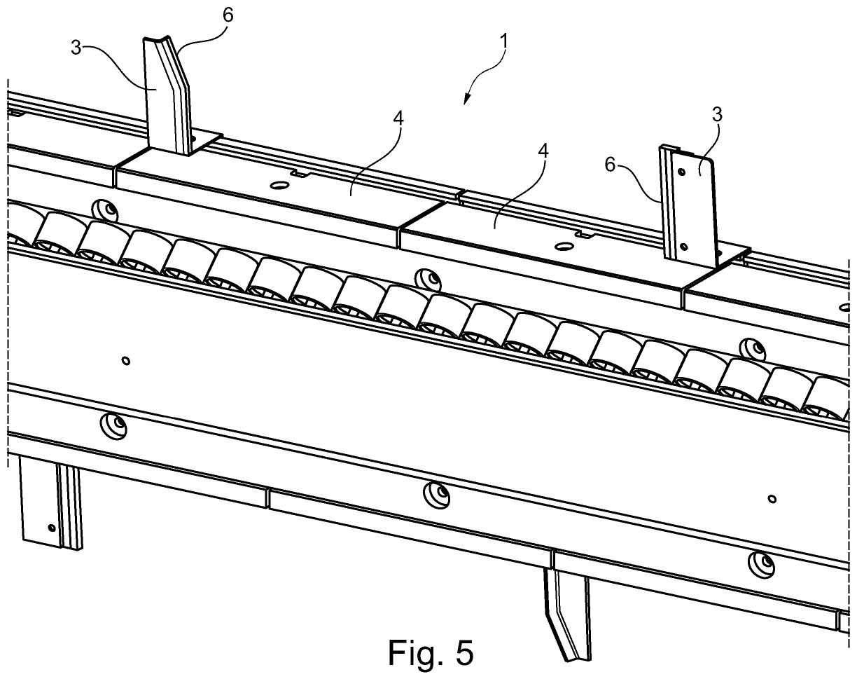

FIGS. 4 and 5 illustrate that the support 4 has at least one T-groove which interacts with a fastening screw and with the pusher 3. The T-groove, which extends in the direction of the longer longitudinal axis of the rectangular support face of the support 4, interacts with the fastener. Here, the head of the screw engages in the T-groove in such a way that the screw is longitudinally displaceable in the T-groove for the purpose of format setting but cannot be rotated about its own axis. The threaded shank of the screw projects up past the support face of the support 4 and extends through an opening (bore) in a foot of the pusher 3, where the foot bears flat on the support face of the support 4. A nut is screwed onto the free end of the threaded shank of the screw and tightened in order to fix the pusher 3 in its desired position on the support 4 for the purpose of format setting or loosened in order to displace the pusher relative to the support for the purpose of format changing.

The traction element, in particular the toothed belt 2, entrains the supports 4 in a suitable manner, that is to say that the supports 4 are displaced by the traction element. This occurs by a schematically illustrated drive 5.

On the basis of the preceding FIGS. 1 to 4, the following will be added with reference to FIG. 5.

FIG. 5 shows that two supports 4 arranged behind one another each have a pusher 3. In the arrangement shown in FIG. 5 of each pusher 3 on its support 4, the maximum spacing between pushers 3 is set. The spacing can be changed, in particular reduced, by changing the position of at least one pusher 3 on its support 4, but also by changing the position of both pushers 3 on their respective supports 4. With regard to FIG. 5, the spacing between the two pushers 3 can thus be reduced in that they are released in their retention with respect to the respective supports 4, moved toward one another and fixed again. Depending on the required format of the plastic bags to be stacked, it can also be conceivable that two or more than two pushers 3 can be mounted and fixed on a support 4 at a spacing which can be varied.

Should greater spacings between two pushers 3 be required, it can also be envisioned that the two supports 4 on each of which a pusher 3 is arranged have arranged between them a further support 4 without a pusher 3.

The pusher 3 is of L-shape. The one leg, which forms a foot by which the pusher 3 lies directly on the support face of the support 4, is preferably shorter than the upwardly projecting leg. Identical or reverse length ratios are also conceivable. Also shown in FIG. 5 at 6 is a holding formation, such as, for example, a rubber lip, a brush, a combination thereof or the like, that holds the stacked bags in position on the support 4 by friction. The projecting free end of a pusher 3 can be beveled (as in the case of the left-hand pusher 3 in FIG. 5) or not (as in the case of the right-hand pusher 3 in FIG. 5).

List of reference signs

| | |
|---|---|
| 1 | Apparatus |
| 2 | Toothed belt |
| 3 | Pusher |
| 4 | Support |
| 5 | Drive |
| 6 | Holding formation |

1. An apparatus for making stacks of plastic-film bags, the apparatus comprising:
a traction element;
a support on which the bags can be laid flat on one another and fastened to the traction element for conveying formed stacks;
a pusher, for advancing the stacked bags; and
means for adjusting a position of the pusher on the support.

2. The apparatus according to claim 1, wherein the apparatus has two of the supports behind one another, wherein one pusher is on each of the supports.

3. The apparatus according to claim 1, wherein the support is substantially planar support face for the bags.

4. The apparatus according to claim 1, wherein the pusher is of L-shape.

5. The apparatus according to claim 1, wherein two of the supports immediately adjacent one another and each having a respective one of the pushers form a planar surface for receiving a plurality of bags stacked above one another.

6. The apparatus according to claim 5, wherein at least one of the pushers has a holding formation.

7. The apparatus according to claim 1, wherein the support has a T-shaped groove and the means includes a fastener engaged in the groove and with the pusher (3).

8. A method forming stacks of plastic-film bags for operating an apparatus according to claim 1.

9. An apparatus for forming and conveying stacks of plastic-film bags, the apparatus comprising:
an endless conveyor element having a stretch movable in a transport direction;
a row of supports each having a planar support face secured to and displaceable with the element, each support being formed with a T-groove extending in the directed and open upwardly on the stretch;
respective L-shaped pushers each having a foot sitting on the face of a respective one of the supports and shiftable in the direction on the support and an upright leg projecting upward from the respective face in the stretch; and
a fastener engaged through each of the feet and into the groove for fixing the respective pusher to the support, the fasteners being loosenable for movement of the respective pusher in the direction on the support and tightenable to prevent such movement relative to the support.
